(19) United States
(12) Patent Application Publication
(10) Pub. No.: US 2007/0016499 A1
(43) Pub. Date: Jan. 18, 2007

(54) Method and apparatus for establishing permanent customer relationships

(75) Inventors: Claire Vishik, Austin, TX (US); Lalitha Suryanarayana, Austin, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/182,594

(22) Filed: Jul. 15, 2005

(51) Int. Cl. G06Q 40/00

(52) U.S. Cl. 705/35; 705/40

(57) ABSTRACT

An account management system (100) has a communications interface (110), a memory (104), and a processor (102). The processor is programmed to receive (202) customer profile information for a customer, determine (204) a credit rating according to the profile information, identify (206) services that can be offered according to the credit rating, establish (208) a permanently active account for said customer, and enable or disable (209) services in response to customer demands.

### FIELD OF THE INVENTION

This invention relates generally to managing customer services, and more particularly to a method and apparatus for establishing permanent customer relationships.

### BACKGROUND OF THE INVENTION

Service providers today manage customer accounts on the basis of active services. That is, when customers terminate service due to a relocation, or modify service in response to a change in family conditions (such as a member of the family attending college remotely), the service providers deactivates the account with respect to that service. Consequently, when the customer attempts to reinstall service at the same location or a new location, the customer will more often than not be prompted by the service provider to reestablish service preferences, and at times the customer will be subjected to a credit check.

In today's mobile environment, this process can be an annoyance to customers and frequently leads a customer to shop around among service providers. Consequently, the potential for a service provider to lose a customer to a competing service provider is high. A need therefore arises for a method and apparatus to establish permanency in customer relationships unencumbered by a change in circumstances that warrant said customers to update services on an ongoing basis.

### SUMMARY OF THE INVENTION

Embodiments in accordance with the invention provide a method and apparatus for establishing permanent customer relationships.

In a first embodiment of the present invention, an account management system has a communications interface, a memory, and a processor. The processor is programmed to receive customer profile information for a customer, determine a credit rating according to the profile information, identify services that can be offered according to the credit rating, establish a permanently active account for said customer, and enable or disable services in response to customer demands.

In a second embodiment of the present invention, an account management system has a computer-readable storage medium. The storage medium has computer instructions for receiving customer profile information for a customer, determining a credit rating according to the profile information, identifying services that can be offered according to the credit rating, establishing a permanently active account for said customer, and enabling or disable services in response to customer demands.

In a third embodiment of the present invention, an account management system operates according to a method having the steps of receiving customer profile information for a customer, determining a credit rating according to the profile information, identifying services that can be offered according to the credit rating, establishing a permanently active account for said customer, and enabling or disabling services in response to customer demands.

### BRIEF DESCRIPTION OF THE DRAWINGS

FIG. 1 is block diagram of an account management system according to an embodiment of the present invention; and

FIG. 2 depicts a flowchart of a method operating in the account management system according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

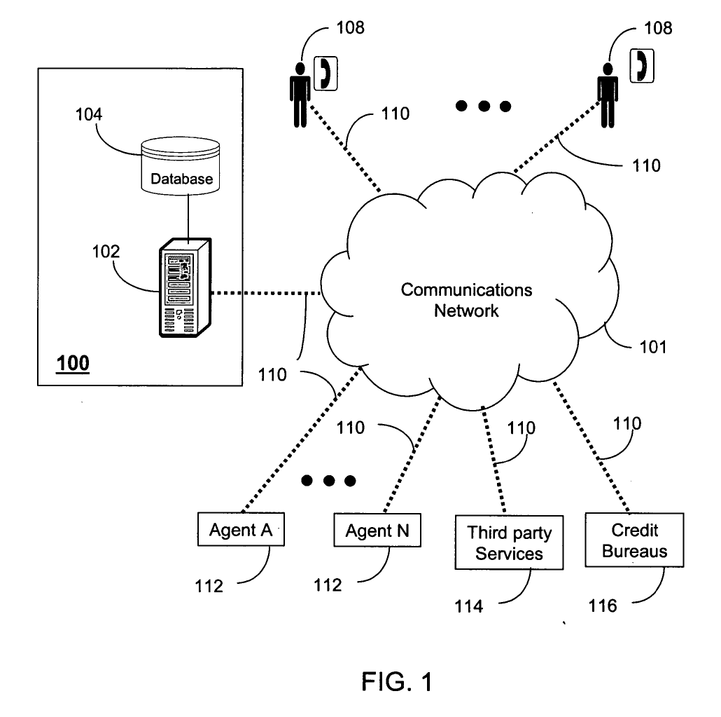

FIG. 1 is block diagram of an account management system (AMS) 100 according to an embodiment of the present invention. The AMS 100 comprises a communications interface 110, a memory 104 and a processor 102. The communications interface 110 is coupled to a conventional communications network 101 managed by a service provider, which interconnects customers 108 and customer service agents 112 operating at, for example, a service center responsible for specific customer support tasks such as technical support, service installation, billing, new accounts, and so on. The communications network 101 is also coupled to third party service providers 114 and credit bureaus 116 as will be discussed shortly.

The communications network 101 and interfaces 110 coupled thereto can operate according to known communications technology such as wired or wireless circuit switched or packet switched networks. Accordingly, POTS (Plain Old Telephone Service) phones, cell phones, VoIP (Voice over Internet Protocol) phones, desktop computers, or other like telecommunication devices can be used for intercommunicating purposes within the confines of the communications network 101.

The memory 104 can be utilized as a database for storing customer account information in relation to services provided to said customers 108. Services can include telecommunications services (Internet, local and long-distance wired services, cellular services, Voice over IP services, etc.), and financial services such as banking and/or investment management, or other services, which the customer 108 can request by way of an agent 112 coupled to the communications network 101. In the present context, an agent 112 can represent a human being accepting calls from a customer 108, a conventional IVR (Interactive Voice Response) system operating in the AMS 100 performing the functions of the human agent, and/or an Internet website provided by the AMS 100 with self-help menus in which the customer 108 can request an update of services provided thereto.

Any database application and/or information management systems (such as a CRM—Customer Relations Management) application can be applied to the present invention. The processor 102 comprises conventional computing technology such as a desktop computer or scalable server for managing operations of the AMS 100 in accordance with the present invention.

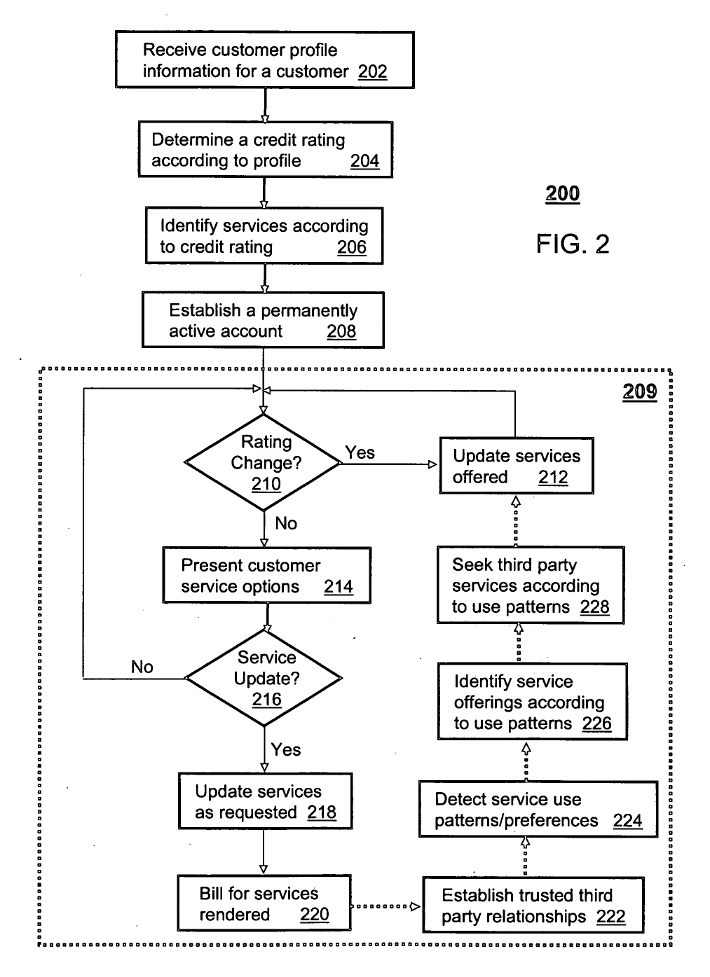

FIG. 2 depicts a flowchart of a method 200 operating in the AMS 100 according to an embodiment of the present invention. Method 200 begins with step 202 where the AMS 100 receives customer profile information from a customer 108. This step can be the result of customer information collected by an agent 112 that includes, for example, the name of customer's employer, customer's residential address, customer's social security number, and so on. In step 204, a determination of a credit rating is performed by the AMS 100 according to the profile information provided. The AMS 100 can perform this function by communicating with one or more credit service bureaus 116 (e.g., Equifax, Transunion, or Experian) to determine the prospective customer's credit rating.

From this rating, the AMS 100 identifies in step 206 services that can be offered to the customer 108. For example, a poor credit rating can result in a reduction of services offered. Alternatively, a poor rating will not result in a reduction of services offered, but can result in higher fees to mitigate risk. Thus, the AMS 100 can be programmed in any manner suitable for mitigating credit risk with the customer 108. Following step 206, the AMS 100 establishes a permanently active account in step 209 for said customer 108, which the customer can use to enable or disable services on demand.

An embodiment of step 209 is illustrated by way of steps 210 through 228. It would be obvious to an artisan with ordinary skill in the art that the embodiment shown for step 209 is but one of numerous embodiments that are applicable to the present invention. Accordingly, the embodiments not shown, but which are suitable for the present invention, should be considered to be within the scope and spirit of the claimed invention.

The embodiment of step 209 begins with step 210, whereby the AMS 100 is programmed to monitor and detect changes in the credit rating of the customer 108. If a change is detected, the AMS 100 proceeds to step 212 where it updates services offered to the customer 108. In the case of an improved rating, more services and/or services at a lower rate can be offered. Where a decrease in rating is detected, less and/or higher priced services may result.

As is evident from the flowchart, the credit rating of the customer 108 is monitored periodically. Such monitoring can occur at suitable intervals (daily, month, quarterly, etc.). If in step 210 there is no change in the credit rating of the customer 108, the AMS 100 proceeds to step 214 where it presents to a customer service options by way of an agent. The options can be self-help options presented by an agent 112 embodied by an IVR or a web page as described earlier. Alternatively, the AMS 100 can communicate service options to a human agent 112 by way of a computer terminal, and the agent 112 can in turn conveys said options to the customer 108 after receiving a call from said customer 108.

If no service updates are required in step 216, the AMS 100 proceeds to step 210 where it repeats the step of monitoring changes in the customer's credit rating. If, on the other hand, the customer has demanded a change in services in step 216, the AMS 100 proceeds to step 218 where it updates services according to the change requested. The update can be a removal or an addition of services. Moreover, the update can be temporal as defined by, for example, an update period for enabling or disabling a service. Assuming the latter case, once the service update period expires, the AMS 100 in step 218 restores services to their prior state and bills in step 220 the customer 108 for services rendered during said period. This approach is very useful for customers who are mobile, or who have transient family members or guests.

There are several supplemental embodiments that can be applied to the aforementioned steps. For instance, in step 222 the AMS 100 can be programmed to establish trusted relationships with third party service providers such as banks or financial institutions according to, for example, the credit rating supplied by the AMS 100 system. The selection of third party services can be enhanced in step 224 whereby the AMS 100 applies conventional applications that, for example, statistically detect service use or preference patterns of the customer 108, which in turn can be used in steps 226 and 228 to seek and/or identify third party service offerings that will enhance customer experience and profitability of the service provider of the AMS 100.

The AMS 100 updates the service offerings in step 212 according to the additional third party services identified in steps 226 and 228. These services are eventually presented again to the customer in step 214 by way of updated self-help agents 212, or a human agent 212. As should be evident from the flowchart of FIG. 2 the account of the customer is permanent and remains active at all times independent of service updates made by the customer. Accordingly, the establishment of an account as performed by steps 202 through 208 is a single transaction, while step 209 and its embodiments are operated on periodically.

The present invention as described is extremely valuable for substantially enhancing customer loyalty and thereby establishing long-term relationships. Under the present invention, customer relationships managed by the AMS 100 evolve with customer needs without the frustrations experienced in prior art systems described earlier.

It should be evident by now that the present invention can be realized in hardware, software, or a combination of hardware and software. Moreover, the present invention can be realized in a centralized fashion, or in a distributed fashion where different elements are spread across several interconnected processors. Thus, any kind of computing device or other apparatus adapted for carrying out method 200 described above is suitable for the present invention.

It should be also evident that the present invention may be used for many applications. Thus, although the description is made for particular arrangements and methods, the intent and concept of the invention is suitable and applicable to other arrangements and applications not described herein. It would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein. A software program in the present context means any expression, in any language, code or notation, of a set of instructions intended to cause a system having an information processing capability to perform a particular function either directly or after either or both of the following: a) conversion to another language, code or notation; b) reproduction in a different material form.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. An account management system, comprising:
a communications interface;
a memory; and
a processor programmed to:
receive customer profile information for a customer;
determine a credit rating according to the profile information;
identify services that can be offered according to the credit rating;
establish a permanently active account for said customer; and
enable or disable services in response to customer demands.

2. The account management system of claim 1, wherein the processor is programmed to:
monitor changes in the credit rating of the customer;
detect a change in the credit rating of the customer; and
update services made available to customer according to the credit rating change.

3. The account management system of claim 1, wherein the processor is programmed to:
detect service use patterns of the customer;
identify service offerings to enhance customer experience and profitability according to detected service use patterns; and
present service offerings to customer.

4. The account management system of claim 3, wherein the processor is programmed to:
seek third party services according to detected use patterns; and
present said third party services to said customer.

5. The account management system of claim 1, wherein the processor is programmed to present customer with self-service options for selecting services.

6. The account management system of claim 5, wherein the processor is programmed to:
detect customer preferences from service updates made by customer; and
update said self-service options according to detected preferences.

7. The account management system of claim 1, wherein the processor is programmed to:
establish trusted relationships with third party services;
detect service use patterns of the customer;
identify third party service offerings to enhance customer experience and profitability according to detected service use patterns; and
present third party service offerings to customer.

8. The account management system of claim 1, wherein the processor is programmed to:
receive a service update request with an update period defined by the customer;
update services according to the service update request; and
restore services to their prior state after the update period expires.

9. In an account management system, a computer-readable storage medium comprising computer instructions for:
receiving customer profile information for a customer;
determining a credit rating according to the profile information;
identifying services that can be offered according to the credit rating;
establishing a permanently active account for said customer; and
enabling or disabling services in response to customer demands.

10. The storage medium of claim 9, comprising computer instructions for:
monitoring changes in the credit rating of the customer;
detecting a change in the credit rating of the customer; and
updating services made available to customer according to the credit rating change.

11. The storage medium of claim 9, comprising computer instructions for:
detecting service use patterns of the customer;
identifying service offerings to enhance customer experience and profitability according to detected service use patterns; and
presenting service offerings to customer.

12. The storage medium of claim 11, comprising computer instructions for:
seeking third party services according to detected use patterns; and
presenting said third party services to said customer.

13. The storage medium of claim 9, comprising computer instructions for presenting customer with self-service options for selecting services.

14. The storage medium of claim 13, comprising computer instructions for:
detecting customer preferences from service updates made by customer; and
updating said self-service options according to detected preferences.

15. The storage medium of claim 9, comprising computer instructions for:
establishing trusted relationships with third party services;
detecting service use patterns of the customer;
identifying third party service offerings to enhance customer experience and profitability according to detected service use patterns; and
presenting third party service offerings to customer.

16. The storage medium of claim 9, comprising computer instructions for:
receiving a service update request with an update period defined by the customer;
updating services according to the service update request; and
restoring services to their prior state after the update period expires.

17. In an account management system, a method comprising the steps of:
receiving customer profile information for a customer;
determining a credit rating according to the profile information;
identifying services that can be offered according to the credit rating;
establishing a permanently active account for said customer; and
enabling or disabling services in response to customer demands.

18. The method of claim 17, comprising the steps of:
monitoring changes in the credit rating of the customer;
detecting a change in the credit rating of the customer; and
updating services made available to customer according to the credit rating change.

19. The method of claim 17, comprising the steps of:
detecting service use patterns of the customer;
identifying service offerings to enhance customer experience and profitability according to detected service use patterns; and
presenting service offerings to customer.

20. The method of claim 17, comprising the steps of:
receiving a service update request with an update period defined by the customer;
updating services according to the service update request;
restoring services to their prior state after the update period expires; and
billing said customer according to services rendered during the update period.
